(19) United States
(12) Patent Application Publication
(10) Pub. No.: US 2006/0235950 A1
(43) Pub. Date: Oct. 19, 2006

(54) Personal internet portal (PIP)

(75) Inventor: Jonathan R. Cowper, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP, Reno, NV (US)

(21) Appl. No.: 11/108,612

(22) Filed: Apr. 18, 2005

(51) Int. Cl. G06F 15/16

(52) U.S. Cl. 709/219

(57) ABSTRACT

The disclosure is directed to a limited application computing device including a processor having an input device interface responsive to user input devices, an output interface to provide communication to a display device, a memory interface to access at least one solid-state memory device, and a network interface coupled to a wireless data communication device. The limited application computing device also includes a nonvolatile solid-state memory coupled to the processor via the memory interface. The nonvolatile solid-state memory stores a limited set of non-user changeable applications that may be executed by the processor.

### BACKGROUND

General purpose computers, such as desktop and laptop personal computers, typically include a hard drive, a floppy drive, or other type of storage device that stores many different computer programs that may be executed. Such general purpose computer devices typically cost several hundred or over a thousand dollars. Personal computers are used as end user devices to access data networks, such as the Internet. Further, personal computers are used as communication devices, such as through electronic mail programs. While general purpose personal computers have been very popular and commercially successful, the cost of acquiring a general purpose personal computer device often precludes certain less affluent people from having access to the Internet and to email. In addition, other problems with conventional personal computers include the relatively long time needed to start-up the computer and the desire for enhanced device portability. Small hand-held personal digital assistant (PDA) devices address some of these problems but PDAs do not provide the same user experience as a personal computer due to lack of a full keyboard and a very small display.

Further, access to the Internet and computer technology is becoming increasingly important in many different environments including in business, at school, and for personal use. Lack of access for a significant portion of the population to personal computer technology and the Internet is considered to be a significant social problem. This problem is sometimes referred to as the “digital divide” since a subset of the population is denied access to digital technology, such as to the Internet and personal computers. Thus, there is a need for an improved computer device to enable more people to gain access to computer technology and to provide greater access to the Internet.

### BRIEF DESCRIPTION OF DRAWINGS

The present disclosure may be better understood, and its numerous features and advantages made apparent to those skilled in the art by referencing the accompanying drawings.

FIG. 1 includes an illustration of an exemplary embodiment of a limited application computing device.

FIGS. 2 and 3 include illustrations of exemplary networks accessible by limited application computing devices, such as the limited application computing device illustrated in FIG. 1.

FIGS. 4, 5 and 6 include illustrations of exemplary methods for use by limited application computing devices, such as the limited application computing device illustrated in FIG. 1.

FIG. 7 includes an illustration of an exemplary embodiment of a limited application computing device.

### DETAILED DESCRIPTION OF THE DRAWINGS

In a particular embodiment, a limited application computing device includes a processor, a network interface and non-volatile solid-state memory and is typically free of spinning readable memory. The non-volatile solid state memory includes a limited set of applications, such as operating system related applications, network access instructions and web browser related applications. Generally, applications stored in the non-volatile solid state memory are not user configurable.

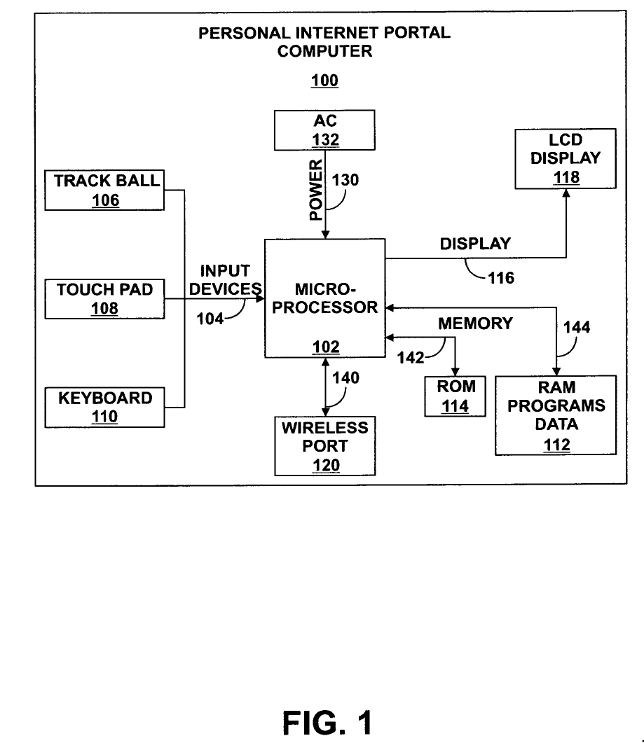

Referring to an exemplary embodiment illustrated in FIG. 1, a limited application computing device, such as a personal Internet portal computer device 100 includes a microprocessor 102 and a display 118. The Internet portal computer device 100 also includes one or more input device interfaces 104 to the microprocessor 102 and a power interface 130. The microprocessor 102 includes a first memory interface 144 and a second memory interface 142. The first memory interface 144 is coupled to a read-write dynamic memory, such as random access memory (RAM) 112 and the second memory interface 142 is coupled to a read-only memory (ROM), which is a non-volatile memory 114. The microprocessor 102 also includes a wireless network interface 140 coupled to a wireless communication port 120. The microprocessor 102 is coupled to the display device 118, such as an LCD display, via output interface 116. The input device interfaces 104 may be coupled to representative computer input devices, such as a track ball 106, a touch pad 108, and a keyboard 110.

The microprocessor 102 is powered via the power interface 130 and power is supplied by an alternating current source 132. Alternatively, the microprocessor 102 is powered by a rechargeable battery.

The interfaces may be hardware or software interfaces. Hardware interfaces may include intervening electronic components. In alternative embodiments, one or more devices and electronic components coupled to the microprocessor 102, such as those described above, are accessed through one or more data busses.

The wireless communication port 120 is configured to communicate using wireless communication standards. For example, a wireless communication device at port 120 may communicate with network equipment using wireless standards, such as infrared standards, IEEE 802.11, EEE 802.15, and IEEE 802.16, Wi-Fi, Wi-Max, and Bluetooth®. In alternative embodiments, the Internet portal computer device 100 may include interfaces for communicating with wired broadband networks, such as digital subscriber line (DSL) and cable networks.

The non-volatile memory 114 may store operating system instructions, network access instructions, and web browser related applications. In one exemplary embodiment, the user is not provided access to the non-volatile memory 114 and the user may not change or add applications. Instead, the supplier, manufacture or Internet service provider (ISP) associated with the Internet portal computer device 100 may access the Internet portal computer device 100 to update applications and data via a network interface when the Internet portal computer device 100 is connected to a network. For example, read only memory, such as the non-volatile memory 114, may be updated with an upgrade communicated from a remote computer to the Internet portal computing device 100 via the wireless communication port 120. In addition, the network access instructions may be configured by the supplier or manufacturer to access a remote network controller associated with a particular Internet service provider (ISP) and identify the presence of the Internet portal computer device 100 on the network. In response, the Internet portal computer device 100 may be provided with access to remote computing resources. When accessing a network from a public access point associated with the ISP, the remote network controller may communicate with equipment local to the Internet portal computer device 100 to facilitate network access.

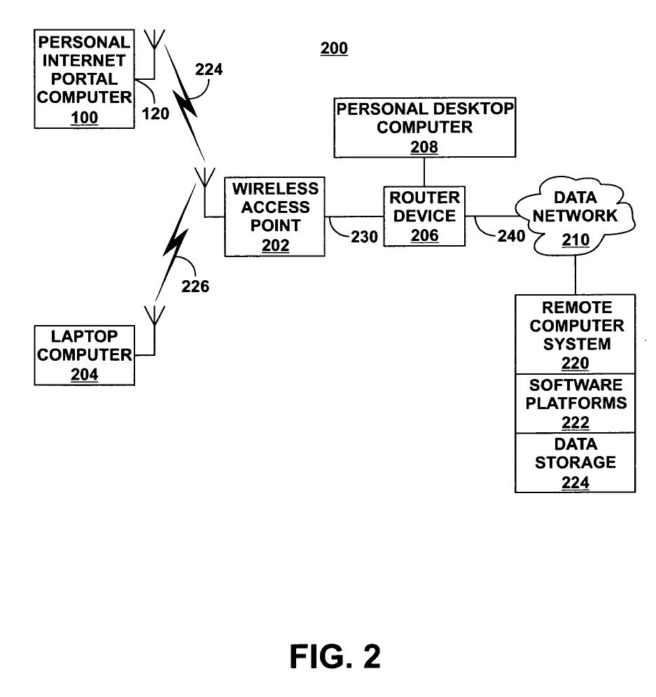

Referring to FIG. 2, a representative system 200 that includes use of the personal Internet portal computer 100 is shown. The system 200 includes a wireless access point 202 that is in communication with the personal Internet portal computer 100 via wireless port 120 and a wireless data communication link 224. The wireless access point 202 may also communicate with other devices, such as the representative laptop computer 204 via wireless data link 226. Wireless access point 202 is coupled over a wire-line network, such as an interface 230 to a data router device 206. The data router device 206 may be coupled to a personal desktop computer 208 and has access to a data network 210 via network interface 240. An example of data network 210 is a public data network, such as the Internet.

The system 200 also includes a remote computer system 220 that is accessible to the personal Internet portal computer via the wireless access point 202, the router device 206 and the data network 210. Remote computer system 220 is coupled to the data network 210 at a remote location. The remote computer system 220 includes software programs 222 and data storage 224. The software programs 222 and data storage 224 may include programs and data respectively that may be used to execute programs remotely for display and use by a user of the personal Internet portal computer 100 and may, for example, provide virtual personal computer functionality. The remote computer system 220 may be a network server that is accessible to multiple user portal computers.

The representative personal Internet portal computer 100 includes a processor having an input device interface responsive to user input devices, an output interface to provide communication to a display device, a memory interface to access at least one solid state memory device and a network interface coupled to a wireless data communication device. The personal Internet portal computer is a limited application computing device that includes a non-volatile solid state memory coupled to the processor. The non-volatile solid state memory stores a limited set of non-user changeable applications that may be executed by the processor. For example, the non-volatile solid state memory may include a ROM that has firmware programmed for executing a browser application. The browser application is embedded within the read-only memory and is not user changeable.

In contrast to traditional desktop and laptop computers, the personal Internet portal computer 100 does not include a hard drive or other spinning readable media devices and does not allow a user to load user changeable software applications for execution on the device. Spinning readable media may include CD-ROMs, DVD-ROMs, floppy drives and hard drives. In this manner, the personal Internet portal computer provides for a reduced set of functions that may be performed efficiently and at very low cost.

The personal Internet portal computer 100, the wireless access point 202, the router device 206, and the personal desktop computer 208 may all be part of a residential network and may be located within a single residence. The connection between router device 206 and the data network 210 may be provided by a broadband service such as digital subscriber line (DSL) service or a cable modem service. In addition, for reduced costs and ease of use, it should be noted that the personal Internet portal computer 100 in certain applications only includes a wireless network connection and includes no other network connections, such as land-line modem connections. In addition, the personal Internet portal computer 100 may be used in many different environments, such as business environments, schools, hospitals, or when accessing a wireless hotspot, such as via an IEEE 802.11 interface.

In a particular embodiment, the personal Internet portal computer is implemented within a portable clamshell-type housing 700. The housing 700 includes the processor, the non-volatile solid state memory and the display device. The housing includes a first portion 702 to house the display device 706 and includes a second portion 704, also referred to as a base portion that includes the processor, the solid state non-volatile memory and at least one of the user input devices 708 such as a keyboard or a mouse. In a particular implementation, the first portion 702 of the housing 700 is detachably connected to the second portion 704 of the housing 700. The second portion 704 coupling 718 of the housing 700 includes an on/off selector 710 and may include an audio jack 714, a universal serial bus (USB) 712, and the housing may include a rechargeable battery compartment 716 to house an optional rechargeable battery.

It should be noted that, in one embodiment, the non-volatile memory within the second portion of the housing does not store any computer user programs, such as word processors or spreadsheets. Use of the personal Internet portal computer 100 in connection with such software programs is conducted only through a network connection and execution at a remote computer, such as the remote computer system 220. The remote networked computer may include memory storage and software applications that may be executed remotely by a user of the Internet portal computer 100 to perform virtual personal computer functions, such as executing computer user programs on the remote computer system.

In a particular embodiment, the remote computer system 220 may control certain actions with respect the personal Internet portal computer 100. For example, the remote computer system 220 may detect a virus and may turn off the personal Internet portal computer remotely via a remote command over the network. In another embodiment, the external remote computer system 220 may turn on power to the personal Internet portal computer 100, such as when a particular problem has been resolved. In a further example, the remote computer system 220 may update firmware on the personal Internet portal computer 100.

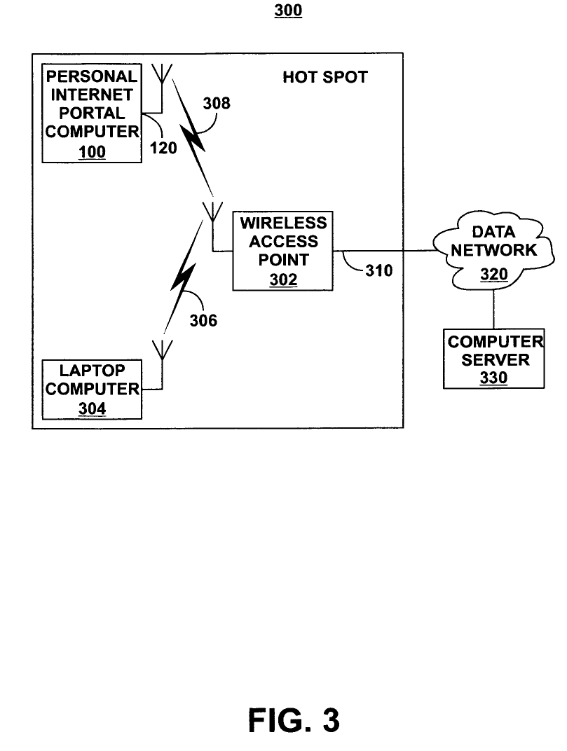

Referring to FIG. 3, a system 300 including a wireless hotspot environment is illustrated. The hotspot environment includes a wireless access point 302 that provides wireless data service to many users. An example of a hotspot may be in a common community location, such as a coffee shop, hotel or airport. As shown, the personal Internet portal computer 100 may access the shared wireless access point 302 within the hotspot via a first wireless data link 308. Other users via various computers, such as the illustrated laptop computer 304, may also access the wireless access point 302 within the hotspot. The wireless access point 302 communicates over a high speed network connection 310 to a distributed data network 320, such as the Internet. The data network 320 allows connection to a remote computer, such as the illustrated computer server 330. The computer server 330 may provide various services and may host web pages and allow retrieval of data and execution of remote programs.

In one particular embodiment, the limited application computing device is configured by a supplier or manufacturer to access only networks associated with a particular ISP. The particular ISP may, for example, provide network access to users via both private access points, such as home networks using wireless or wired connections to DSL or cable service, and public access points located in various locations, such as retail establishments, schools, and public areas. For example, the limited application computing device may access a private access point having an architecture, such as the network architecture illustrated in FIG. 2, and may access a public access point having an architecture, such as the network architecture illustrated in FIG. 3.

For example, the limited application computing device may access a private access point provided by a particular ISP and identify itself to a remote access controller. In one exemplary embodiment, the limited application computing device provides an identifier to the remote access controller, such as a serial number, telephone number, or account number. For example, the limited application computing device may provide a telephone number associated with a DSL account or their subscriber account to the remote access controller. The remote access controller may then provide remote computing resources to the limited application computing device, such as providing the address of a server having available capacity or providing network permission to access a set of servers.

When accessing a public access point associated with the particular ISP, the limited application computing device may send a request to the remote access controller. The request may, for example, include the identifier of the limited application computing device. The remote access controller may identify and authenticate a subscription to provide service. The remote access controller may facilitate network access with network equipment local to the limited application computing device and associated with the public access point. For example, the remote access controller may provide permission or password information to the limited application computing device. Alternatively, the remote access controller may communicate with the network equipment to identify the limited application computing device as a trusted device or device with permission to access the network.

In one particular embodiment, the supplier or manufacturer of the limited application computing device may limit access of the limited application computing device to networks provided by the particular ISP. In addition, the ISP may prevent the limited application computing device from accessing any network when a subscription lapses. Further, the ISP may limit access of the limited application computing device to networks if a virus or suspicious activity is detected from the limited application computing device.

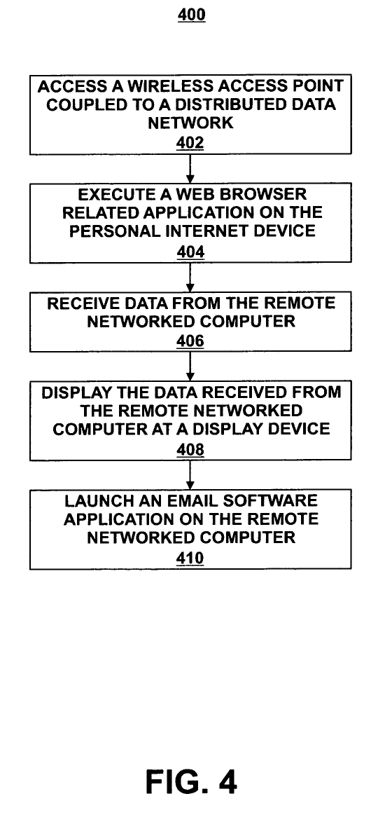

Referring to FIG. 4, a method of communicating between a personal Internet device and a remote network computer is shown. The method includes accessing a wireless access point coupled to a distributed data network using a wireless data interface device, at 402. The method further includes executing a web browser related application on the personal Internet device that is retrieved from a non-volatile solid state memory embedded within the personal Internet device, at 404. The method further includes receiving data from the remote network computer via the wireless data interface and the wireless access point coupled to the distributed data network, at 406, and displaying the data received from the remote network computer aided display device, at 408. With the personal Internet device, no user software applications, other than the web browser related application stored within the firmware on the non-volatile solid state memory, may be executed by the processor within the personal Internet device. In a particular embodiment, the personal Internet device may include components and a structure as illustrated with respect to FIG. 1.

In a particular embodiment, the method may further include launching remotely executed applications, such as launching an e-mail software application on the remote network computer where at least one mail message may then be displayed at the display device within the personal Internet computer device, at 410. Other typical e-mail functions such as reading, sending, storing and modifying e-mail's may be performed via remote execution of the e-mail software on the remote system. The remote e-mail software system may be provided via a web-based interface type system. Other remotely executable software applications include word processor programs and spreadsheet programs. In certain applications, the software programs may include education applications, such as in a school environment or specific business applications, such as warehousing and inventory, where such systems are deployed within a suitable and complimentary business environment.

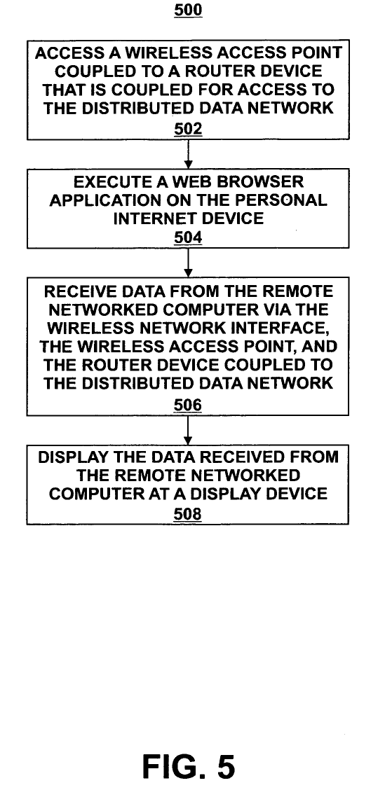

Referring to FIG. 5, a method of communicating between a personal Internet device and a remote network computer having access to a distributed data network is illustrated. The method includes accessing a wireless access point coupled to a router device that is also coupled for access to the distributed data network, at 502. The method further includes executing a web browser application on the personal Internet device where the web browser application is retrieved from a non-volatile solid state memory embedded within the personal Internet device, at 504. In a particular application, the personal Internet device may be as shown with respect to FIG. 1. The method further includes receiving data from the remote network computer via a wireless network interface, a wireless access point, and a router device that is coupled to the distributed data network, as shown at 506. The method further includes displaying the data that was received from the remote network computer at a display device, at 508.

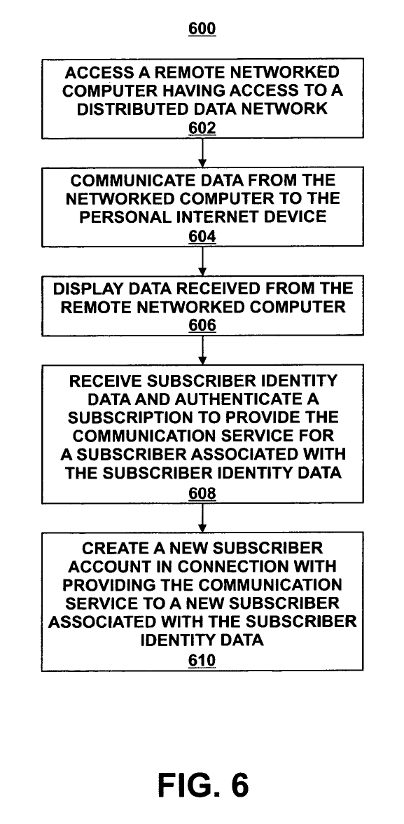

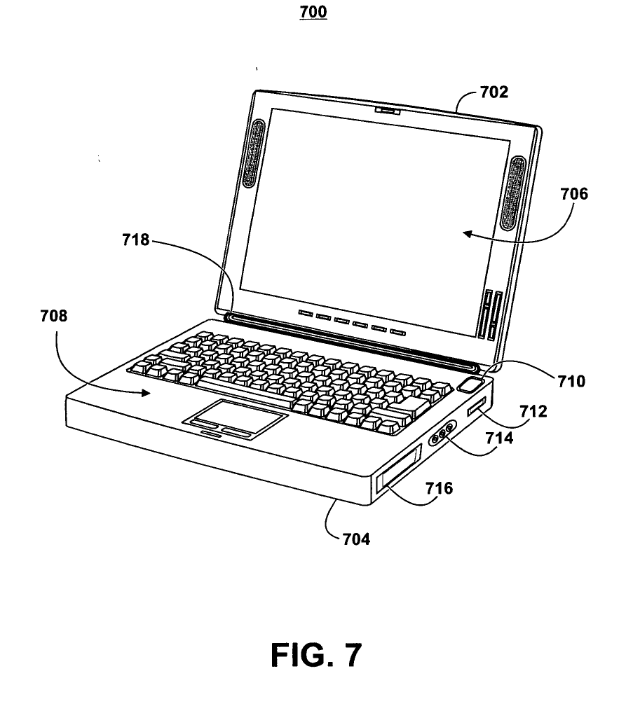

Referring to FIG. 6, a method of providing a communication service is illustrated. The method includes accessing a remote network computer having access to a distributed data network by providing access to a wireless access point coupled to a router device that is also coupled for access to a distributed data network, as shown at 602. The remote network computer is accessed in cooperation with execution of a web browser application that is retrieved from a non-volatile solid state memory within the personal Internet device. The method further includes communicating data from the network computer via the wireless network interface, a wireless access point, and a router device over a data communication path, to the personal Internet device, as shown at 604. Data received by the personal Internet device may be displayed, as shown at 606.

In a particular embodiment, the method may further include providing the personal Internet device, a wireless access point, and a router device to a subscriber as part of a bundled service offering. In another embodiment, the method of providing a communication service may further include receiving subscriber identity data and authenticating a subscription to provide the communication service for a subscriber associated with the subscriber identity data, as shown at 608. A method may further include creating a new subscriber account in connection with providing the communication service to a new subscriber associated with a subscriber identity data, as shown at 610.

In another example, a method of accessing a network includes receiving a network access request at a remote network controller associated with a particular Internet service provider from a limited application computing device. The network access request includes an indicator associated with the limited application computing device. The limited application computing device includes a processor, a network interface accessible to the processor and non-volatile solid state memory coupled to the processor. The non-volatile solid state memory includes supplier configured network access instructions operable by the processor to access a particular internet service provider via a private access point and a public access point and web browser related applications operable by the processor to interact with remote computing systems via the particular internet service provider. The method further includes providing network access permission data to network access equipment local to the limited application computing device and providing Internet access to the limited application computing device via the network access equipment. In one embodiment, the indicator includes a telephone number associated with a digital subscriber line or other account.

The disclosed system may include an Internet access device that uses wireless fidelity (Wi-Fi) as a connection technique to a remote network station. The disclosed system and method provides a user with a high degree of mobility and versatility in which to connect to the Internet. In addition, the Internet portal computer may be provided at a very low cost. The device is designed from solid state components that are lighter and faster than hard drive components found in booted personal computers. In addition, a limited application design allows for faster and better operation as a vehicle for access to the Internet. In addition, the disclosed system and method takes advantage of distributed data networks to attract and retain subscribers.

Further, the system and method disclosed may be useful for providing additional services, such as wireless data and broadband services for rapid deployment in people's homes and. in public areas throughout the nation. The disclosed system thereby utilizes Wi-Fi technology and the Internet to offer extended Internet access to additional segments of the population. The disclosed system provides a very low cost alternative to a personal computer and may also be used as a satellite terminal with respect to a family personal computer via a home network.

Additionally, at school, the system may be provided for classroom assignments and may be used via server based computer applications shared across student terminals. In addition, the disclosed system and method may be used in public assisted housing where central services could be utilized such as centralized printers, server based software applications, and shared storage systems. The disclosed system may be provided at a significantly lower cost than traditional personal computers. Other uses for the personal Internet portal include libraries, warehouses and other environments where desktop computers and laptops are now placed. Furthermore, such access points may be provided by a specific ISP through retailers who subscribe to the ISP, resulting in increased sales at the retailer. Such retailers include coffee shops, restaurants, and bars.

Note that not all of the activities described above in the general description or the examples are required, that a portion of a specific activity may not be required, and that one or more further activities may be performed in addition to those described. Still further, the order in which activities are listed are not necessarily the order in which they are performed.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

The above disclosed subject matter is to be considered illustrative, and not restrictive, and the appended claims are intended to cover all such modifications, enhancements, and other embodiments which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A limited application computing device comprising:
a processor having an input device interface responsive to user input devices, an output interface to provide communication to a display port, a memory interface to access at least one solid-state memory device, and a network interface coupled to a wireless data communication device;
a nonvolatile solid-state memory coupled to the processor via the memory interface, the nonvolatile solid-state memory storing a limited set of non-user changeable applications that may be executed by the processor.

2. The limited application computing device of claim 1, wherein the user input devices include a keyboard and a pointing device.

3. The limited application computer device of claim 1, wherein the limited set of non-user changeable applications includes a web browser application to facilitate a network connection to a remote computer using the wireless data communication port.

4. The limited application computer device of claim 3, wherein the web browser program is a firmware program stored at a nonvolatile memory.

5. The limited application computer device of claim 1, wherein the wireless data communication port is provided by a wireless fidelity (Wi-Fi) type communication component that provides access to a Wi-Fi network via an access point.

6. The limited application computer device of claim 5, wherein the network interface is limited to providing network access to wireless access through the wireless data communication port.

7. The limited application computing device of claim 1, wherein the processor is coupled to a second solid-state memory device, the second solid-state memory device comprising a read-write dynamic memory.

8. The limited application computer device of claim 1, further comprising a portable clamshell type housing, the housing including the processor, the nonvolatile solid-state memory, and the display device.

9. The limited application computer device of claim 8, wherein the housing includes a first portion that includes the display device and includes a second portion that includes the processor, the solid-state nonvolatile memory, and at least one of the user input devices.

10. The limited application computer device of claim 9, wherein the first portion is detachably connected to the second portion.

11. The limited application computer device of claim 10, wherein the second portion is a base portion and wherein the base portion includes a power interface and wherein the base portion further includes a pointing device, and an on/off selector.

12. The limited application computer device of claim 1, wherein the nonvolatile memory does not store any computer user programs.

13. The limited application computer device of claim 12, wherein the computer user programs are stored and executed only at a remote computer accessible via the wireless data interface and are not executed by the processor.

14. The limited application computer device of claim 1, wherein a read only memory upgrade is communicated from a remote computer to the limited application computer device via the wireless communication device to update the nonvolatile memory.

15. The limited application computer device of claim 1, wherein an external computer, via a wireless data network, controls operation of the processor to turn on or turn off power to the limited application computer device.

16. A method of communicating between a personal internet device and a remote networked computer, the method comprising:
accessing a wireless access point coupled to a distributed data network using a wireless data interface device;
executing a web browser related application on the personal internet device that is retrieved from a non-volatile memory embedded within the personal Internet device, wherein no user software applications, other than the web browser related application, may be executed by a processor within the personal Internet device;
receiving data from the remote networked computer via the wireless data interface and the wireless access point coupled to the distributed data network; and
displaying the data received from the remote networked computer at a display device.

17. The method of claim 16, wherein the personal internet device comprises:
a processor having an input device interface responsive to user input devices, an output interface to provide communication to the display device, a memory interface to access at least one solid-state memory device, and a network interface coupled to a wireless data communication device; and
a nonvolatile solid-state memory coupled to the processor via the memory interface, the nonvolatile solid-state memory storing the web browser related application that is executable by the processor.

18. The method of claim 16, further comprising launching an email software application on the remote networked computer and wherein at least one email message may be displayed at the display device.

19. The method of claim 16, further comprising shutting down the personal internet device in response to receiving a power-off indication from the remote networked computer.

20. The method of claim 19, wherein the remote networked computer includes memory storage and software applications that may be executed remotely by a user of the personal internet device to perform virtual personal computer functions.

21. A method of providing a communication service, the method comprising:
accessing a remote networked computer having access to a distributed data network, by providing access to a wireless access point coupled to a router device that is coupled for access to the distributed data network;
wherein the remote networked computer is accessed in cooperation with execution of a web browser application on the personal internet device that is retrieved from a non-volatile memory embedded within the personal internet device, wherein the personal internet device comprises a processor dedicated to execution of non-user changeable applications, the processor having an input device interface responsive to a user input device, an output interface to provide communication to a display device, a memory interface to access data from at least one solid-state memory device, and a wireless network interface coupled to a wireless data communication port, the nonvolatile solid-state memory coupled to the processor via the memory interface, the nonvolatile solid-state memory storing the web browser application that is executable by the processor; and
communicating data from the networked computer via the wireless network interface, the wireless access point, and the router device over a data communication path to the personal internet device.

22. The method of claim 21, further comprising providing the personal internet device, the wireless access point and the router device as part of a bundled service.

23. The method of claim 21, further comprising receiving subscriber identity data and authenticating a subscription to provide the communication service for a subscriber associated with the subscriber identity data.

24. The method of claim 23, wherein the subscriber identity data is a telephone number.

25. A limited application computing device comprising:
a processor;
a network interface accessible to the processor; and
nonvolatile solid state memory coupled to the processor and comprising:
supplier configured network access instructions operable by the processor to access a particular internet service provider via a private access point and a public access point; and
web browser related applications operable by the processor to interact with remote computing systems via the particular internet service provider.

26. The limited application computing device of claim 25, wherein the supplier configured network access instructions are non-user changeable.

27. The limited application computing device of claim 25, wherein the supplier configured network access instructions are configured to prevent access to internet service providers other than the particular internet service provider.

28. The limited application computing device of claim 25, wherein the public access point is a wireless access point accessible with communication protocols selected from a group consisting of Wi-Fi, Wi-Max, and Bluetooth.

29. The limited application computing device of claim 28, wherein the private access point is provided via a network selected from a group consisting of digital subscriber lines and cable.

30. The limited application computing device of claim 25, wherein the supplier configured network access instructions are configured to access a remote service provider controller via the network interface, the remote service provider controller configured to facilitate local network access.
